(19) United States
(12) Patent Application Publication
(10) Pub. No.: US 2020/0293565 A1
(43) Pub. Date: Sep. 17, 2020

(54) REPAIR ACTION LABEL GENERATION SYSTEM

(71) Applicant: General Electric Company, Schenectady, NY (US)

(72) Inventors: Tapan SHAH, Bangalore (IN); Uwe WIEDMANN, Niskayuna, NY (US)

(21) Appl. No.: 16/353,515

(22) Filed: Mar. 14, 2019

(51) Int. Cl. G06F 16/35; G06N 20/00

(52) U.S. Cl. CPC G06F 16/358; G06N 20/00

(57) ABSTRACT

The example embodiments are directed to a system and method which can identify a plurality of labels from free-form text included in a corpus of repair actions. The system and method can further label each repair action with a label from the determined plurality of labels. In one example, the method may include storing a plurality of repair action entries which each comprise unstructured free-form text associated with actions performed, generating a term matrix comprises a list of words extracted from the plurality of repair action entries and mapped to the plurality of repair action entries based on frequency of use within free-form text thereof, determining a plurality of labels for categorizing the actions performed via execution of a non-negative matrix factorization based on the created term matrix, and outputting information about the determined plurality of labels for display via a user interface.

### BACKGROUND

Service repairs are often performed to maintain assets such as devices, equipment, machinery, infrastructure, utilities, and the like, which are used in industry, business, government, and residential installations. Service repairs may be performed in response to a service request that has been provided because of a failure or malfunction with an asset. As another example, service repairs may include preventive or scheduled maintenance as a cost-effective practice to ensure that the asset does not fail. Typically, a service request can be entered by a customer while a repair action may be created by a technician after he or she has addressed the service request.

Recently, machine learning has been used to remotely troubleshoot and provide diagnostics of service requests raised by a customer. The machine learning is typically trained using historical services requests and repair actions which can be used to identify patterns between the two. The resulting algorithm can be used to predict a repair or maintenance that is necessary. To convert the service repairs into data that can be used for training purposes, a group of labels (or buckets) must be identified which define different categories of repair actions.

However, a repair action is typically an unstructured text object (free-form text) without any standardized format or language. Instead, terminology that is used within the repair action is chosen subjectively by the engineer/technician that prepared the repair action. As a result, identifying common or standard labels for categorizing the unstructured repair actions can be difficult. Typically, a user (such as a subject matter expert) must manually create a number of labels for the repair actions. This requires the user to read through at least a small set of service repair actions and make a judgment as to which labels should be applied. This can take considerable time. Furthermore, it is infeasible for the user to manually read a large corpus of repair actions (e.g., thousands, etc.). As a result, the labels determined by the user are not very comprehensive and are usually limited to the preferences of the user.

### SUMMARY

The embodiments herein improve upon the prior art by providing an automated label determination system which can identify a finite set of labels from among a large corpus of service repair actions. Furthermore, based on the identified labels, the system can further categorize each of the service repair actions in a corpus of historical repair actions as being associated with at least one label from among the set of labels and output the results via a user interface. The labels can be used in a subsequent training process for building a supervised learning algorithm for predicting repair actions to be taken.

The service repair actions include descriptions composed of free-form text. Often, a technician or engineer will document the problem, the action taken, and the result, and store this information as a repair action document or text object. The system described herein can receive many historical service repair actions and generate a dictionary of words which include unigram terms extracted from the free-form text of the repair actions. All unique words may initially be extracted and then the list of words may be cleaned or trimmed down by removing various stop words (conjunctions, articles, prepositions, etc.) and generic words that do not discretize between different types of repair actions. The system may create a term matrix based on the remaining words in the dictionary of words.

For example, the term matrix may include a list of words on one axis and the repair actions on another axis, mapped to each other to create an array of cells. The cells may include an identifier that indicates a frequency of use of each word with respect to each repair action. According to various embodiments, the system may execute a non-negative matrix factorization (NMF) operation which can decompose the term matrix into two smaller matrices including a topic-to-keyword matrix and a topic-to-action matrix. The topic-to-keyword matrix may identify a plurality of topics (i.e., a plurality of labels). Furthermore, the topic-to-keyword matrix may indicate which words in the dictionary (keywords) are associated with each respective topic. Meanwhile, the topic-to-action matrix may map the plurality of topics to the plurality of repair actions. The cells of the topic-to-action matrix may indicate a likelihood of a repair action being associated with a corresponding topic. Based on the likelihoods in the topic-to-action matrix, the system can estimate which label (i.e., topic) a repair action is most closely associated with (belongs to).

The learning system may also provide a user interface which allows a user to enter feedback input regarding the labels and the keywords associated with the labels. The system described herein may convert the user feedback into modifications to the topic-to-keyword matrix and the topic-to-action matrix. For example, the system can convert the feedback into instructions which can mathematically modify the content of one or more elements of the topic-to-keyword matrix and/or the topic-to-action matrix. Examples of feedback include addition, deletion, renaming, splitting, and merging of topics/labels. As another example, feedback may include modifying keywords associated with the labels (e.g., modifying a weight given to keywords, etc.) The feedback collection and the matrix modification may be performed by the same software or it may be performed by different pieces of software. For example, a first piece of software may implement the user interface, while a second piece of software receives the feedback input from the user interface, and mathematically modifies the matrices.

In an aspect of an example embodiment, a computing system may include a storage configured to store a plurality of repair action entries which each comprise unstructured free-form text associated with actions performed, and a processor configured to generate a term matrix that comprises a list of words extracted from the plurality of repair action entries and which are mapped to the plurality of repair action entries based on frequency of use within free-form text thereof, determine a plurality of labels for categorizing the actions performed via execution of a non-negative matrix factorization based on the generated term matrix, and output information about the determined plurality of labels for display via a user interface.

In an aspect of another example embodiment, a method may include storing a plurality of repair action entries which each comprise unstructured free-form text associated with actions performed, generating a term matrix that comprises a list of words extracted from the plurality of repair action entries and which are mapped to the plurality of repair action entries based on frequency of use within free-form text thereof, determining a plurality of labels for categorizing the actions performed via execution of a non-negative matrix factorization based on the generated term matrix, and outputting information about the determined plurality of labels for display via a user interface.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a labeling system for determining a set of service repair labels in accordance with an example embodiment.

FIG. 2A is a diagram illustrating a non-negative matrix factorization (NMF) algorithm in accordance with an example embodiment.

FIG. 2B is a diagram illustrating a term matrix for use with the NMF in accordance with an example embodiment.

FIG. 3 is a diagram illustrating a NMF process for decomposing a term matrix into a topic-to-keyword matrix and a topic-to-action matrix in accordance with an example embodiment.

FIG. 4 is a diagram illustrating an example of a user interface for providing feedback in accordance with an example embodiment.

FIG. 5 is a diagram illustrating a method for determining a set of labels for service repair actions in accordance with an example embodiment.

FIG. 6 is a diagram illustrating a computing system for use with any of the example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a learning system that uses non-negative matrix factorization to learn the approximate number of topics (labels) of corrective repair action seen by a services team, or the like. The learning system can identify similar types of corrective repair actions, cluster them and assign a common label thereto. Furthermore, the learning system provides a mechanism in which feedback provided by a human (e.g., subject matter expert) can be used to mathematically refine an element of the non-negative matrix factorization. The learning system can create a labeled training set of repair actions which can be used for training machine learning models for automated troubleshooting of repair orders in a fast and accurate manner.

Supervised machine learning is often performed to predict what kind of service needs to be performed (e.g., condition-based maintenance, and the like). In order for a machine learning algorithm to be created there must be a labeled set of training data. The machine learning algorithm uses the labeled training data to identify patterns (e.g., what request triggered what action, etc.). The actions are not infinite and may be limited to a smaller set of actions such as 20 actions, 50 actions, 100 actions, or the like.

Within the historical repair action data, the description of the action taken is typically in free-form unstructured text. Furthermore, engineers/technicians may describe the work they performed for handling a service request in different ways. The same action may have a very different description. Therefore, allowing the machine learning to learn can be difficult. The goal is to find a way to create the buckets (labels) for each type of action that was performed and to commonly label actions in the same bucket even when their descriptions are not exactly alike. However, the actions are written in free text which makes it difficult to convert the free-form text into standardized buckets.

To address this problem in an automated manner, the learning system described herein generates a term matrix from a dictionary of words which are acquired from historical repair actions. The term matrix may include a listing of the words on one axis, and the list of repair actions on the other axis. The cells of the term matrix may identify a frequency of use of the words within each repair action. The system may then perform a non-negative matrix factorization to decompose the term matrix into a topic-to-keyword matrix and a topic-to-action matrix. The topic-to-keyword matrix may include keywords mapped to each topic and may be determined based on commonly used words in a cluster of similar repair actions clustered together. Meanwhile, the topic-to-action matrix may include likelihood indicators that a repair action is associated with each respective topic which can be used to estimate a label (topic) from among the plurality of topics for each of the repair actions.

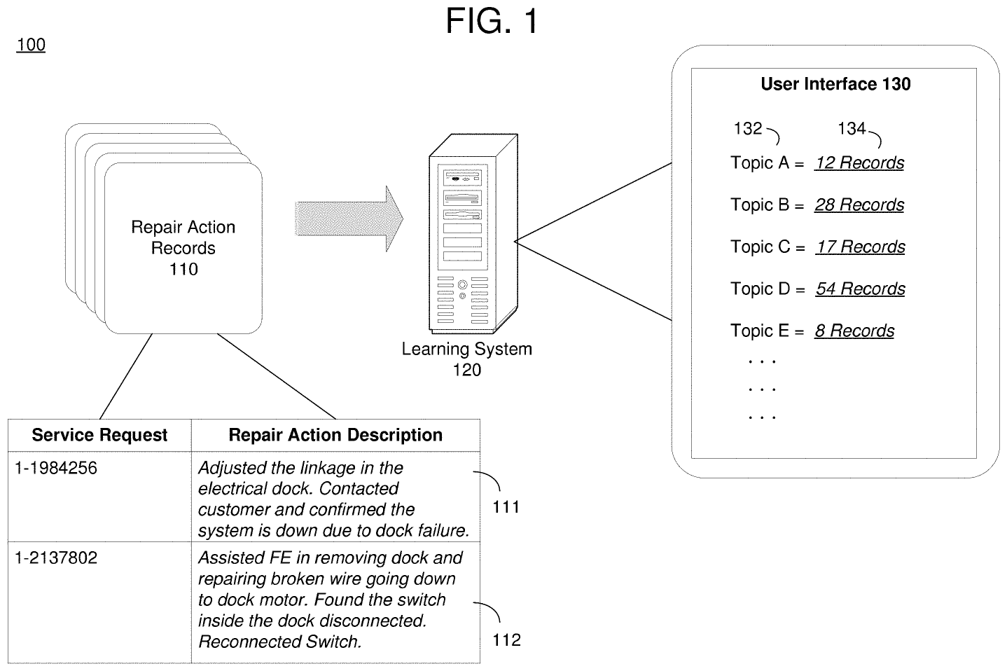

FIG. 1 illustrates a process 100 of a learning system 120 determining a set of service repair labels in accordance with an example embodiment. Referring to FIG. 1, the learning system may receive a corpus of repair action records 110 which may include service request information and actions performed in response to the service request. The learning system 120 may generate a term matrix (as further described below) and decompose the term matrix based on NMF into a set of labels for use in categorizing the repair action records 110. The labels may be a finite set of labels even though the repair actions include free-form text describing the actions without a structured format. In addition, the decomposing may also generate a topic-to-action matrix which maps each of the repair action records 110 to each of the plurality of labels, and then provides a likelihood indicator of whether the repair action record is associated with each label. The output of the learning system 120 may be a user interface 130 which includes a listing of the different labels 132 along with an identification of which repair action records 134 are included in each label 132.

In the example of FIG. 1, two examples of service repair action records are shown as repair action description 111 and repair action description 112. The repair action descriptions 111 and 112 include free-form text with descriptions of the actions taken to address a service request. Here, the verbiage used in the descriptions 111 and 112 is very different but it refers to the same repair action taken (fixing electrical dock). Many of these (e.g., thousands, etc.) may be included in the repair action records 110. The learning system 120 described by the example embodiments provides a mechanism for figuring out how to classify or label these unstructured descriptions into buckets or classes that are associated with a same action. The learning system may determine a finite number of categories for the repair actions. As an example, the learning system 120 can receive thousands of repair action records 110 while identifying a small set (e.g., 20, etc.) categories of labels.

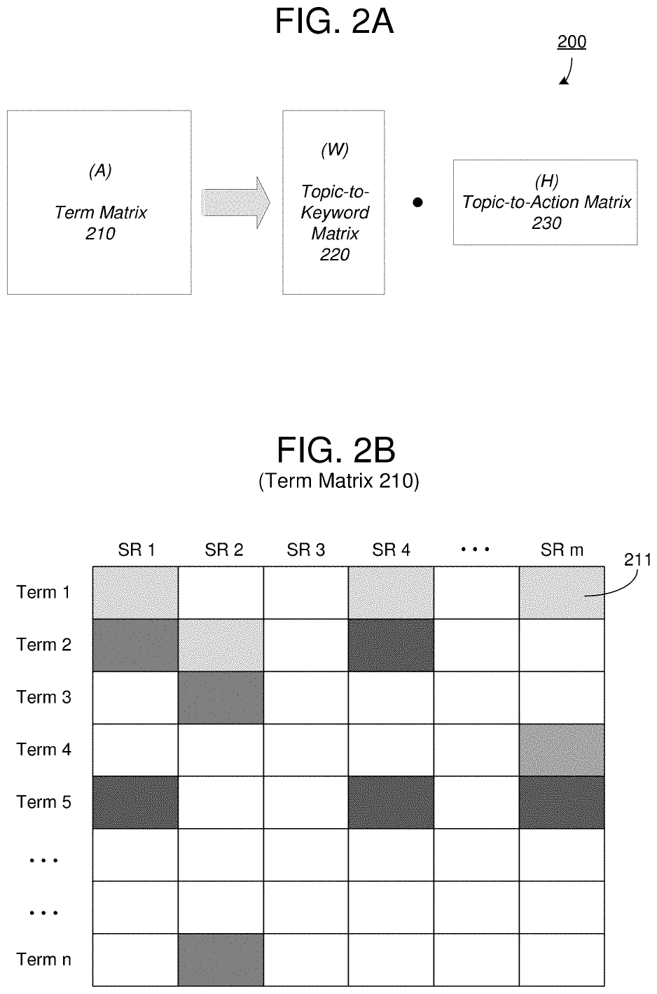

The learning system 120 may collect a bunch of historical service action repair records and create a matrix format such as shown in the example of the term matrix 210 shown in FIG. 2B. The term matrix 210 may be created using words that are extracted from the repair action records 110 with some cleaning. For example, conjunctions, prepositions, articles, etc., may be removed, as well as terms that are not distinct to any particular category of service repair and which cannot discriminate among the different types of repairs. In addition, the learning system 120 may perform various cleaning steps such as removing duplicate actions, part replacements, actions where no problem is found, and the like. Thereafter, certain domain based non-informative words are removed and a dictionary of remaining words such as bigrams, unigrams n-grams, and the like, is created. This dictionary is used to create a term-document matrix with a number of rows equal to a number of service requests in the historical corpus and number of columns equal to the number of words in dictionary.

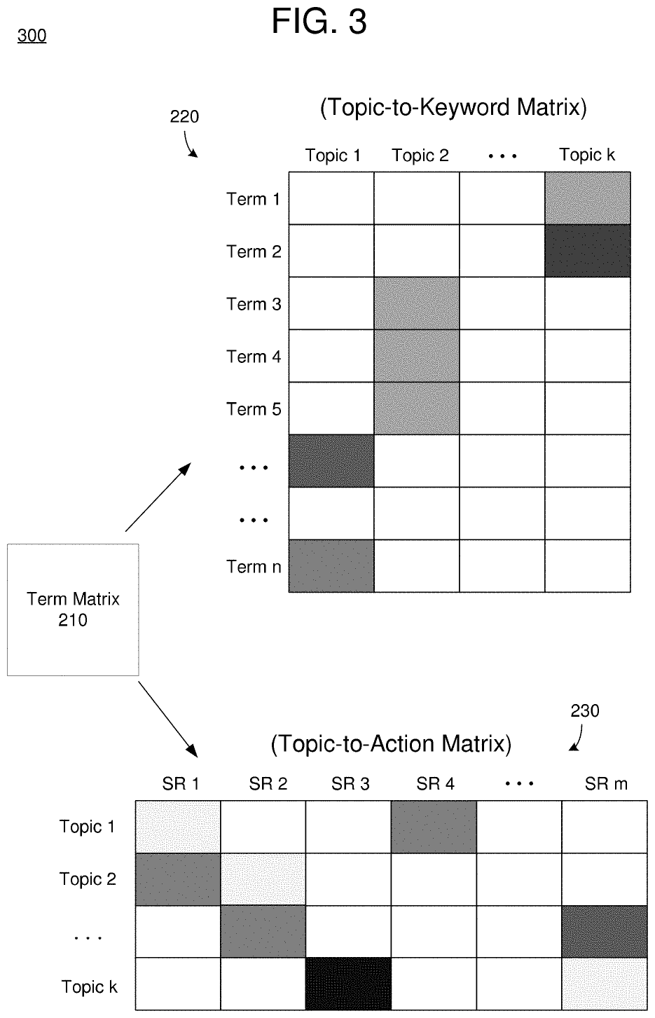

Non-negative matrix factorization (NMF) based labeling may be performed based on the created term matrix. For example, the learning system 120 may define a metric reconK(k) and choose that value of k which minimizes it (examples are shown in FIGS. 2A, 2B, and 3). This value of k is the number of labels or “repair topics” in the given context. Thereafter, the learning system 120 may use the NMF to obtain matrices W and H which correspond to a topic-to-keyword matrix (W) which correlates labels to a subset of keywords in the dictionary, and a topic-to-action matrix H which indicates a likelihood that a repair action corresponds to each of the topics. The matrices may be used to obtain the keywords associated with each topic and allocate each repair action to a particular theme or topic.

The learning system 120 may also incorporate feedback from a subject matter expert which is received via the user interface 130. Examples of the types of feedback include, but are not limited to, addition of labels (topics), deletion of any unimportant labels, renaming of labels, modifying keywords associated with the labels, merging two or more similar labels together into a single label, and splitting a label that is too generic into more than one label. Each of these options may be output to the user interface 130. In response to receiving any of these feedbacks, the learning system 120 may automatically modify the topic-to-keyword matrix and/or the topic-to-action matrix by modifying the content included in rows and/or columns of the topic-to-keyword matrix and/or the topic-to-action matrix.

The learning system 120 can abstract out key repair issues from the repair action corpus with free-text descriptions of repair actions performed and create a labeled training set with a finite number of labels, which is essential for creating a robust multi-class supervised learning model. The system may use limited human feedback which the system can use to mathematically modify the topic-to-keyword matrix and/or the topic-to-action matrix. Some of the advantages of the learning system include a novel metric to be optimized to determine the number of topics in the corpus, making a first level of labeling scalable, and efficient in terms of speed and manhours utilized. Furthermore, because the clustering of ‘issues’ is done after analyzing the entire corpus, it is more comprehensive unlike a complete manual effort which will iteratively look at few sample cases to come up with mapping rules. Furthermore, the system provides a formalized feedback mechanism to incorporate expert feedback thereby making the process more streamlined.

FIG. 2A illustrates a non-negative matrix factorization (NMF) algorithm 200 in accordance with an example embodiment. Topic modeling is a machine learning technique which can be used to softly cluster documents in a corpus by representing each document as a weighted combination of topics. Some popular methods to perform topic modeling are Latent Semantic Indexing (LSI), Latent Dirichlet Allocation (LDA), and Non-negative Matrix Factorization (NMF). The learning system described herein uses NMF because of the following reasons:

1. Due to the inherent sparsity constraints in NMF, it is observed (empirically) to work better for short, noisy text. In our case, via an ad-hoc inspection, topics obtained by NMF were qualitatively better than those obtained by LDA.

2. It is easier to incorporate feedback in the NMF based topic modeling approach.

3. LDA is highly sensitive to hyperparameter tuning compared to NMF.

Non-negative factorization is a dimensional reduction technique in which the low rank factor matrices are constrained to be non-negative. Suppose [symbol] non-negative matrix. The goal of non-negative matrix factorization, with a desired lower dimension of k, is to determine two matrices W∈ [symbol] ^{n×k} and H∈ [symbol] ^{k×m} such that A≈WH. In the example of FIG. 2A, the matrix A corresponds to a term matrix 210, the matrix W corresponds to a topic-to-keyword matrix 220, and the matrix H corresponds to a topic-to-action matrix 230. These matrices are further described below and illustrated in FIG. 2B and FIG. 3. These matrices are found by solving the following optimization problem:

$${min}_{W > 0 , H > 0} {‖ A - WH ‖}_{F} , \qquad ( Eq . 1 )$$

where ∥·∥F is defined as the Frobenius norm of the matrix. The above optimization problem (Equation 1) is solved by solving the following two sub-problems alternately until convergence is achieved:

$$W ← arg {min}_{W > 0} {‖ A - WH ‖}_{F} , H ← arg {min}_{H > 0} {‖ A - WH ‖}_{F} .$$

This method is referred to as alternative non-negative least squares (NNLS).

FIG. 2B illustrates an example of the term matrix 210 for use with the NMF in accordance with an example embodiment. In the examples herein, the matrix A from the NMF algorithm 200 is the term matrix 210 which is generated based on a dictionary of words that are collected from free-form text (unigrams) of a corpus of repair action records. Based on the term matrix 210, the topic-to-keyword matrix 220 and the topic-to-action matrix 230 can be generated.

A first axis (y axis) of the term matrix 210 is the dictionary of words after conjunctions, generic terms, and redundancies have been removed. In total, the dictionary includes n words or more generically, n-grams. A second axis (x axis) of the term matrix 210 is the corpus of repair action records. In total, m repair action records are included. Individual cells 211 are created based on the rows of words overlapped with the columns of repair action. Each cell may provide an indicator which indicates how many times a word is included in a repair action. In the examples herein, colors or shading are used to indicate a value within the cells, however, embodiments are not limited thereto. Other examples include numerical values, etc.

The term matrix 210 may be generated from a large data file that includes textual objects or documents of description included within a corpus of repair action records. Examples of the type of data included in the repair actions include, but are not limited to:

1) Service Dispatch Type—nature of the service call (planned, unscheduled, etc.)

2) Service Request Number—unique identifier of each service request.

3) Service Request Activity Number—number of activities taken by a service engineer in an effort to solve the problem, within each Service Request.

4) Problem Found—The problem to be addressed by the service request.

5) Action Taken—The action(s) taken to solve the problem.

6) Verification—Test results to verify the solution taken.

7) Action Code—debrief item to be filled by a service engineer that requires the engineer to choose from a list of predefined action codes.

The learning system herein can perform a plurality of steps in order to convert the initial data file including the corpus of repair actions into the term matrix 210. For example, the learning system may perform one or more of the following:

1) Removal of SR with multiple activities: Many a times, for SR's with multiple activities, there is often discrepancy in the text written for different activities which can lead to confusion. For ensuring clean data in the topic modeling, we use those repair actions which have only one activity excluding ‘No Problem Found’. Since we are interested only in generating the set of labels and the associated labeling function for each label, this filter does not hamper the learning of the labeling process (as long as we have sufficient examples).

2) Removal of duplicates: Using regular expressions, the system may search for variants of the term “duplicates” in the verification text and remove those repair actions.

3) Removal of part replacements: In several repair actions, part replacement may be required. The parts replaced are stored in a separate database. Such repair actions are labeled by the corresponding part replaced and hence are not included in the subsequent process.

4) Removal of No Problem Found: For repair actions where the Action Code corresponds to ‘No Problem Found’ they are removed.

5) Dictionary Creation and Stopword removal: A stopword list is created and includes common conjunctions, articles, preposition as well as domain related unimportant words that do not discern between different topics of action. After removing these words, a dictionary of remaining unigram terms is created after applying standard methods like stemming and lemmatization.

6) Generation of the term matrix 210 which includes a matrix where the columns are labeled with repair actions (m total) and the rows are labeled with the words from the created dictionary (n total) to create a n×m matrix using a TF-IDF method.

7) Removing repair actions with automated messages: Many times, the Action Taken column contains automated messages. Issues related to these messages are already known and hence need to be removed during pre-processing. In absence of any identifier for such messages, the system may use a heuristic method to identify and eliminate them.

FIG. 3 illustrates a NMF process 300 for decomposing the term matrix 210 into the topic-to-keyword matrix 220 and the topic-to-action matrix 230 in accordance with an example embodiment. There is no definitive way to compute the number of topics (i.e., labels) for a corpus of repair actions using NMF. The example embodiments define a metric reconK=log∥A−WH∥_{F}²+λk for each value of k ranging from 15 to 75 and choose the value that minimizes reconK. The value of

$$λ = \frac{1}{κ ( A )} where κ ( \cdot ) = \frac{( {σ}_{max} )}{{σ}_{1}}$$

is defined as the condition number and σₘₐₓ, σ₁ are the maximal and minimal singular values of A. The reconstruction error ∥A−WH∥_{F}² is a natural method to choose the best k. However, this has a natural bias to a higher k, and therefore the new metric is used.

Referring to FIG. 3, a python function for NMF in SciKit Learning can be used to create the topic-to-keyword matrix 220 and the topic-to-action matrix 230 from the term matrix 210. The topic-to-keyword matrix 220 provides an indicator of how likely it is that a dictionary term appears in each topic. Here, the system may identify a top t keywords that identify a topic as described in Algorithm 1 below which can be used to estimate the top t words for a topic.

(Algorithm 1)

| Data: basis matrix W, t | |
|---|---|
| Result: Top t words for each topic | |
| For i 1 : k do | |
| | topind = argsort (W[:,i]) |
| | top Words = Dictionary [topind [1:t]] |

end.

In the example of FIG. 3, the terms 3, 4, and 5, commonly appear in the second topic. Meanwhile, the topic-to-action matrix 230 provides a likelihood that an action is associated with each topic. The system can use the topic-to-action matrix 230 to estimate which topic a repair action is associated with as shown in Algorithm 2 below.

(Algorithm 2)

| Data: coefficient matrix H | |
|---|---|
| Result: Topic index for each document | |
| For i 1: NCOL(H) do | |
| | Ki = argmax (H[:,i]) |

end.

In the example of FIG. 3, the first repair action is determined to belong to the second topic. Therefore, the system can assign a label (topic 2) to the first repair action record.

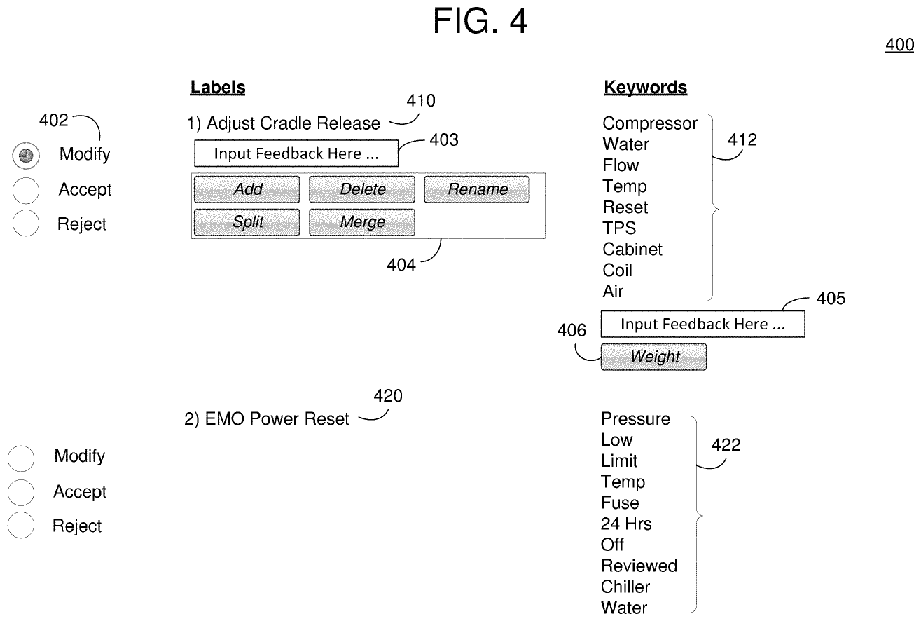

The learning system may also provide a user interface (such as user interface 400) shown in FIG. 4, which allows a user to provide feedback regarding the labels and keywords. In response, the learning system can generate instructions which change the topic-to-keyword matrix 220 and the topic-to-action matrix 230. Furthermore, the system can take the feedback and mathematically modify the content of one or more elements of the topic-to-keyword matrix 220 and/or the topic-to-action matrix 230.

Referring to FIG. 4, the user interface 400 includes a plurality of labels 410 and 420 which have been generated by the system. In this example, the label 410 includes a plurality of keywords 412 associated therewith, and the label 420 includes a plurality of keywords 422 associated therewith. The user interface 400 also provides a list of options (radio buttons) which can be used to modify, accept, or reject a label. In this example, a modify button 402 associated with the first label 410 is selected causing a box 404 of buttons and text box 403 for providing user feedback with respect to the label 410. In addition, the modify button 402, when selected, may also cause a weight button 406 to appear and a text box 405 for inputting modifications to weights of the keywords 412 associated with the label 410. When a modification is performed, the system may create instructions to mathematically modify one or more of the topic-to-action matrix and the topic-to label matrix.

The following Table 1 provides a list of six example feedback inputs that can be entered using the user interface 400, and the resulting mathematical operation performed by the learning system described herein.

TABLE 1

| Feedback Type | Description | Mathematical Update |
|---|---|---|
| Addition | User provides | The system adds a new |
| | a new topic/ | column to W with is at the |
| | label to be added | location of corresponding |
| | | keywords. Re-run the |
| | | NNLS optimization to get |
| | | the updated values of H |
| | | and W |
| Deletion | User deletes a topic | The system deletes the |
| | | column in W. Rerun the |
| | | NNLS optimization to get |
| | | the updated values of H |
| | | and W |
| Rename | A label is renamed | The system creates a |
| | | mapping which maps the |
| | | old label to the new label |
| Keyword | User provides | For each column in the |
| Modification | a different | matrix W, the |
| | weight to a keyword | corresponding weight of |
| | | the word that was re- |
| | | weighed is modified and |
| | | NNLS is re-run using the |
| | | modified W as the |
| | | initialization. |
| Merging | User merges | In matrix W, the two |
| | two labels | columns to be merged are |
| | into a single label | removed and replaced by a |
| | | single column which is the |
| | | weighted sum of the two |
| | | deleted columns. With this |
| | | modified W, the NNLS is |
| | | re-run to get updated W |
| | | and H. |
| Splitting | User splits a | The corresponding column |
| | label into two | is removed and replaced by |
| | or more labels | two columns with is at the |
| | | locations of the |
| | | corresponding keywords. |
| | | The NNLS is re-run to get |
| | | updated W and H. |

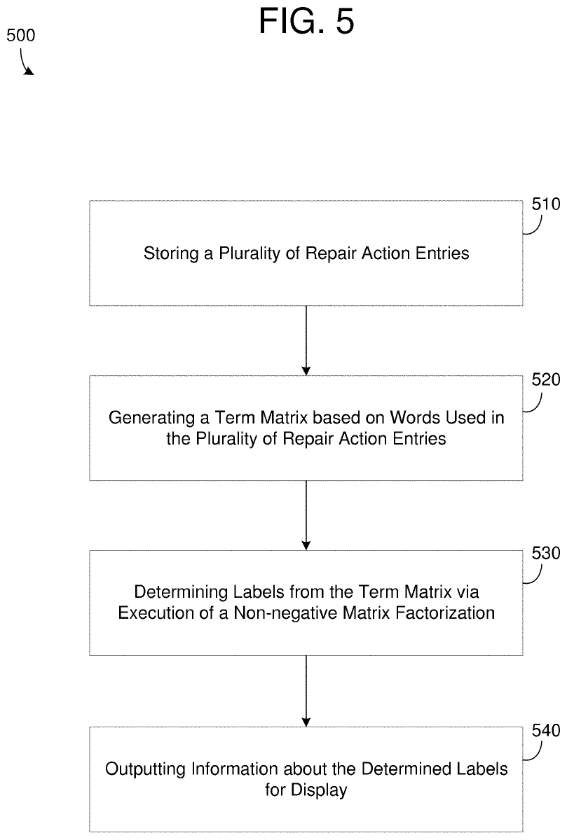

FIG. 5 illustrates a method 500 for determining a set of labels for service repair actions in accordance with an example embodiment. For example, the method 500 may be performed by a learning system which may include a web server, a cloud platform, a user device, a workstation, or the like. Referring to FIG. 5, in 510, the method may include storing a plurality of repair action entries which each comprise unstructured free-form text associated with actions performed. The repair action entries may be received through a data file which includes textual descriptions of repair actions taken in response to service requests or the like. For example, the repair action entries may include unstructured textual descriptions of repair services performed.

In 520, the method may include generating a term matrix that comprises a list of words extracted from the plurality of repair action entries and which are mapped to the plurality of repair action entries based on frequency of use within free-form text thereof. The term matrix may include the term matrix 210 shown in the example of FIG. 2B, and may include a list of words from the plurality of repair actions which have been combined into a single list. The words may be cleaned to remove generic terms, conjunctions, articles, and the like, to create a meaningful list of words capable of discerning different categories of repair actions.

In 530, the method may include determining a plurality of labels for categorizing the actions performed via execution of a non-negative matrix factorization based on the generated term matrix, and in 540, the method may include outputting information about the determined plurality of labels for display via a user interface. In some embodiments, the determining the plurality of labels may include identifying a finite number of repair themes based on a correlation of keywords included in the generated term matrix, and assigning each repair theme as a respective label. For example, the determining may include identifying similar repair action entries based on words in the list of words, clustering the similar types of repair action entries into a cluster, and assigning a label to the clustered repair action entries based on the non-negative matrix factorization.

In some embodiments, the determining may include decomposing the term matrix into a topic-to-keyword matrix that comprises mappings between the list of words and the plurality of labels based on the generated term matrix. In some embodiments, the method may further include decomposing the term matrix into a topic-to-action matrix in which likelihoods that a repair action entry is associated with each of the plurality of labels are identified. In some embodiments, the outputting may further include outputting a respective label for each of the plurality of repair action entries for display via the user interface based on the generated topic-to-action matrix.

In some embodiments, the method may further include receiving user feedback input via a user interface, and modifying the generated topic-to-keyword matrix based on the received user feedback. The user interface may be the same software which is being used to perform the learning. As another example, the user interface may be a separate piece of software from the learning system. The user feedback may include a command that includes one or more of deleting, adding, renaming, merging, and splitting a label. As another example, the command may modify a weight that is applied to keywords. The modifying may include generating and applying instructions which mathematically modify one or more of the topic-to-keyword matrix and the topic-to-action matrix.

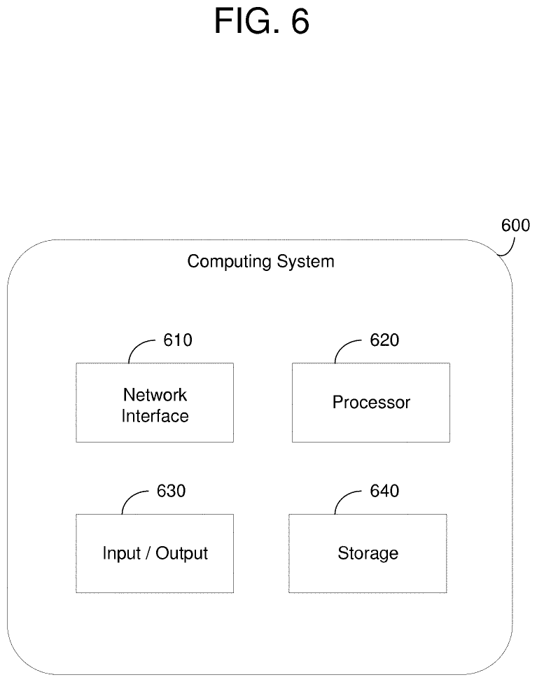

FIG. 6 illustrates a computing system 600 in accordance with an example embodiment. For example, the computing system 600 may be a cloud platform, a server, a user device, or some other computing device with a processor. Also, the computing system 600 may perform the method of FIG. 6. Referring to FIG. 6, the computing system 600 includes a network interface 610, a processor 620, an input / output 630, and a storage device 640. Although not shown in FIG. 6, the computing system 600 may include other components such as a display, a microphone, a receiver/transmitter, and the like. In some embodiments, the processor 620 may be used to control or otherwise replace the operation of any of the components of the computing system 600.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. The input/output 630 may be a hardware device that includes one or more of a port, an interface, a cable, etc., that can receive data input and output data to (e.g., to an embedded display of the device 600, an externally connected display, an adjacent computing device, a cloud platform, a printer, an input unit, and the like. The storage device 640 is not limited to any particular storage device and may include any known memory device such as RAM, ROM, hard disk, and the like.

According to various embodiments, the storage 640 may store a data file, document, or the like, which includes data of a plurality of repair action entries which each comprise unstructured free-form text associated with actions performed. The processor 620 may generate a term matrix that comprises a list of words extracted from the plurality of repair action entries and which are mapped to the plurality of repair action entries based on frequency of use within free-form text thereof. The processor 620 may determine a plurality of labels for categorizing the actions performed via execution of a non-negative matrix factorization based on the generated term matrix. The processor 620 may output information about the determined plurality of labels for display via a user interface. The repair action entries may include unstructured textual descriptions of repair services performed.

According to various embodiments, the processor 620 is configured to determine a finite number of repair themes based on a correlation of keywords included in the generated term matrix, and assign each repair theme as a respective label. For example, the processor 620 may identify similar repair action entries based on words in the list of words, cluster the similar types of repair action entries into a cluster, and assign a label to the clustered repair action entries based on the non-negative matrix factorization.

For example, the processor 620 may decompose the term matrix into a topic-to-keyword matrix that comprises mappings between the list of words and the plurality of labels based on the generated term matrix. In addition, the processor 620 may decompose the term matrix into a topic-to-action matrix in which likelihoods that a repair action entry is associated with each of the plurality of labels are identified. In some embodiments, the processor 620 may output a respective label for each of the plurality of repair action entries for display via the user interface based on the generated topic-to-action matrix. In some embodiments, the processor 620 may output a user interface which receives user feedback input via the user interface, and modify the generated topic-to-keyword matrix based on the received user feedback.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage configured to store a plurality of repair action entries which each comprise unstructured free-form text associated with actions performed; and
a processor configured to generate a term matrix that comprises a list of words extracted from the plurality of repair action entries and which are mapped to the plurality of repair action entries based on frequency of use within free-form text thereof, determine a plurality of labels for categorizing the actions performed via execution of a non-negative matrix factorization based on the generated term matrix, and output information about the determined plurality of labels for display via a user interface.

2. The computing system of claim 1, wherein the repair action entries comprise unstructured textual descriptions of repair services performed.

3. The computing system of claim 1, wherein the processor is configured to determine a finite number of repair themes based on a correlation of keywords included in the generated term matrix, and assign each repair theme as a respective label.

4. The computing system of claim 1, wherein the processor is configured to identify similar repair action entries based on words in the list of words, cluster the similar types of repair action entries into a cluster, and assign a label to the clustered repair action entries based on the non-negative matrix factorization.

5. The computing system of claim 1, wherein the processor is configured to decompose the term matrix into a topic-to-keyword matrix that comprise mappings between the list of words and the plurality of labels based on the generated term matrix.

6. The computing system of claim 5, wherein the processor is further configured to decompose the term matrix into a topic-to-action matrix in which likelihoods that a repair action entry is associated with each of the plurality of labels are identified.

7. The computing system of claim 6, wherein the processor is further configured to receive user feedback and apply instructions which mathematically modify at least one of the topic-to-keyword matrix and the topic-to-action matrix based on the received user feedback.

8. The computing system of claim 7, wherein the user feedback input comprises receiving a command including one or more of deleting, adding, renaming, merging, and splitting a label.

9. The computing system of claim 6, wherein the processor is further configured to output a respective label for each of the plurality of repair action entries for display via the user interface based on the generated topic-to-action matrix.

10. A method comprising:
storing a plurality of repair action entries which each comprise unstructured free-form text associated with actions performed;
generating a term matrix that comprises a list of words extracted from the plurality of repair action entries and which are mapped to the plurality of repair action entries based on frequency of use within free-form text thereof;
determining a plurality of labels for categorizing the actions performed via execution of a non-negative matrix factorization based on the generated term matrix; and
outputting information about the determined plurality of labels for display via a user interface.

11. The method of claim 9, wherein the repair action entries comprise unstructured textual descriptions of repair services performed.

12. The method of claim 9, wherein the determining the plurality of labels comprises identifying a finite number of repair themes based on a correlation of keywords included in the generated term matrix, and assigning each repair theme as a respective label.

13. The method of claim 9, wherein the determining comprises identifying similar repair action entries based on words in the list of words, clustering the similar types of repair action entries into a cluster, and assigning a label to the clustered repair action entries based on the non-negative matrix factorization.

14. The method of claim 9, wherein the determining comprises decomposing the term matrix into a topic-to-keyword matrix that comprise mappings between the list of words and the plurality of labels based on the generated term matrix.

15. The method of claim 14, wherein the decomposing further comprises decomposing the term matrix into a topic-to-action matrix in which likelihoods that a repair action entry is associated with each of the plurality of labels are identified.

16. The method of claim 15, wherein the method further comprises receiving user feedback, and generating and applying instructions which mathematically modify at least one of the topic-to-keyword matrix and the topic-to-action matrix based on the received user feedback.

17. The method of claim 16, wherein the receiving the user feedback input comprises receiving a command including one or more of deleting, adding, renaming, merging, and splitting a label.

18. The method of claim 15, wherein the method further comprises outputting a respective label for each of the plurality of repair action entries for display via the user interface based on the generated topic-to-action matrix.

19. A non-transitory computer-readable medium comprising instructions which when executed by a processor cause a computer to perform a method comprising:
storing a plurality of repair action entries which each comprise unstructured free-form text associated with actions performed;
generating a term matrix comprises a list of words extracted from the plurality of repair action entries and mapped to the plurality of repair action entries based on frequency of use within free-form text thereof;
determining a plurality of labels for categorizing the actions performed via execution of a non-negative matrix factorization based on the created term matrix; and
outputting information about the determined plurality of labels for display via a user interface.

20. The non-transitory computer-readable medium of claim 17, wherein the determining the plurality of labels comprises identifying a finite number of repair themes based on a correlation of keywords included in the created term matrix.
